(19) United States
(12) Patent Application Publication
(10) Pub. No.: US 2017/0120507 A1
(43) Pub. Date: May 4, 2017

(54) DEVICE FOR PRE-ASSEMBLING PARTS, WITH THE INTERPOSITION OF MASTIC, AND PRE-ASSEMBLY METHOD

(71) Applicant: STELIA AEROSPACE, Rochefort-Cedex (FR)

(72) Inventors: Stéphane GRATECAP, Breuil Magne (FR); Xavier MORAND, Tonnay Charente (FR); Hervé DUCOURNEAU, Rochefort (FR)

(21) Appl. No.: 15/129,340

(22) PCT Filed: Mar. 10, 2015
(86) PCT No.: PCT/EP2015/054892

§ 371 Date: Sep. 26, 2016

(30) Foreign Application Priority Data
Apr. 4, 2014 (FR) 1453026

(51) Int. Cl. B29C 65/48; B29C 65/00

(52) U.S. Cl. CPC B29C 65/48; B29C 66/028; B64F 5/10

(57) ABSTRACT

The invention relates to a method for pre-assembling parts with the insertion of mastic, including surface preparation carried out by spraying cold plasma produced by a plasma gun carried by a preparation robot, onto the surfaces of the parts to be brought into contact, and deposition of fresh mastic on the prepared surfaces of at least one part, carried out using the preparation robot.

### CROSS-REFERENCE TO RELATED APPLICATIONS

This application is the National Stage International Application No. PCT/EP2015/05492, having an International Filing Date of 10 Mar. 2015, which designated the United States of America, and which International Application was published under PCT Article 21(2) as WO Publication No. 2015/150027 A1, and which claims priority from, and the benefit of, French Application No. 1453026, filed on 4 Apr. 2014, the disclosures of which are incorporated herein by reference in their entireties.

### BACKGROUND

1. Field

The presently disclosed embodiment belongs to the field of the assembly of structures.

More particularly, the disclosed embodiment belongs to the field of the assembly of structures that have to ensure a sealing and protection against the phenomena of corrosion under micro-displacement as is known in aircraft structures subjected to vibratory environments and to fatigue phenomena.

More particularly, the disclosed embodiment relates to a device for preparing parts to be assembled with the interposition of a mastic, and a method for pre-assembling the parts.

2. Brief Description of Related Developments

In the field of assembly and in particular of the assembly of structural parts in aeronautical construction, it is known practice to deposit, between the faces of the parts having to be placed in contact, a mastic such as a polymerizable mastic, for example the mastics designated PR™, of which there are numerous varieties suited to particular conditions.

The mastic ensures the sealing of the assembly, to air for example for the panels of a pressurized fuselage or to a liquid for example in the case of a fuel tank. The mastic also produces a mechanical bond absorbing the micro-displacements which inevitably occur between the assembled parts subjected to a vibratory environment that can be severe.

To ensure these functions, the mastic retains, throughout the life of the assembly in which it is incorporated, properties of elastomers which ensure a mechanical bond that is both strong and resilient and that avoids direct friction between the parts.

In order to perfectly follow the surface of the parts and adhere to these surfaces, the mastic is deposited in a pasty state then polymerized when the parts to be assembled are positioned relative to one another.

The mastics implemented are, for example, two-component mastics which, once mixed, will lead to the polymerization.

The mastic can be implemented for a more or less lengthy duration which depends on the type of mastic and on the conditions, in particular the temperature of storage thereof and that of its implementation.

For the mechanical bond between the parts with the interposition of mastic to be of good quality and for the sealing to be assured, it is essential for the mastic to adhere to the surface of the parts.

This mastic adhesion quality is obtained by a preparation of the surfaces of the parts to which the mastic has to adhere.

The preparation of the surfaces is all the more important as most of the individual parts that have to be assembled have received a surface treatment and/or a coating deposition which is not necessarily suitable for promoting the adhesion of the mastic.

Furthermore, the individual parts have generally been handled and have spent time in a workshop or in stores before being assembled and their surfaces may have been contaminated by dust, grease, generally all kinds of aerosols to which can be added a physicochemical modification of the surfaces by phenomena of oxidation in air.

Thus, it is known practice in the assembly workshops to proceed with a preparation of the surfaces to which the mastic has to adhere.

Most often, a first degreasing of the surfaces is carried out manually using a solvent-soaked towelette, followed by a stripping using an abrasive pad, followed by a repeat degreasing using a solvent-soaked towelette.

After this preparation, the mastic is deposited, for example by a roller or by spatula, on the prepared surfaces, generally within a time delay that is dictated to avoid having the prepared surfaces undergo new pollutions, and the parts to be assembled are positioned together then fixed and clamped temporarily by assembly pins pending a subsequent step of fitting of the final fastening devices.

It is also known practice to perform these operations by robotized means.

In this case, each part is fixed to a holding frame and a robot arm performs a stripping by means of a sanding machine, for example an orbital sander, then proceeds with a degreasing in several passes, for example three passes, with solvent-soaked towelettes and finally performs the deposition of the mastic. The parts are then pre-assembled.

These two solutions, manual and robotized, have in common the defects of generating dust in the stripping step, dust which pollutes the environment of the workshop and the assembly zone, and of implementing solvents whose use imposes restrictive safety standards with respect to people and which offer risks of pollution that can ultimately lead to the prohibition of their use.

The control of the risks for the health of the operators linked to the handling of the products, solvents and mastics, and musculoskeletal disorders is a significant constraint, particularly in the case of a manual application which, furthermore, does not make it possible to guarantee a constant quality of the result or optimized consumption of the consumables.

For its part, the robotized method, without avoiding the use of the consumables, towelettes and solvents, demands numerous handling operations and proves also costly in time.

### SUMMARY

The presently disclosed embodiment proposes a method for the pre-assembly of a first part with at least one second part and with the interposition of a mastic in which the surfaces of the first and of the second part or parts having to be placed in contact are subjected to a surface preparation operation followed by the deposition of a fresh polymerizable mastic on the prepared surface of at least one of the first or second parts and in which the first part and at least one second part are pre-assembled by temporary fastening devices.

According to the disclosed embodiment, the method comprises the steps of:
preparation of the surfaces, having to be placed in contact, of the first part and of at least one second part by the spraying, onto the surfaces to be prepared, of a cold plasma jet generated by at least one cold plasma torch borne by an effector of a preparation robot, then;
cooling of said surfaces having to be placed in contact to a temperature below a temperature allowed for the deposition of fresh mastic, then;
deposition of a bead of fresh mastic, by means of the preparation robot, on the surfaces having to be placed in contact of the first part and/or of the at least one second part, then;
positioning, by the preparation robot, of said at least one second part on the first part, then;
fitting of temporary fastening devices and clamping said at least one second part with the first part by a pinning robot, when the mastic is still fresh.

A surface preparation step is thus performed without damage to the surface of the part, perfectly localized by a form of the plasma jet, without the generation of dust and without the use of solvent. Furthermore, the deposition of mastic, for example a two-component mastic PR™ polymerizable at ambient temperature of a workshop marketed by the company Le Joint Français of the Hutchinson group, performed rapidly after the surface preparation, in principle without intermediate storage of the prepared parts, thus avoiding the prepared surface from being polluted before the deposition of the mastic.

According to one aspect for implementation of the method, the bead of fresh mastic is deposited by means of a nozzle of a mastic production unit, by displacement of said nozzle borne by the effector of the preparation robot over previously prepared surfaces of the first part and/or at least one second part, said first and second parts being kept individually fixed on frames. It is thus possible to deposit the bead of fresh mastic on complex forms of parts of large dimensions by exploiting the displacement and orientation capabilities of the effector of the preparation robot.

According to another method, the preparation robot displaces a part, held by gripping means of the effector of said preparation robot, to deposit a bead of fresh mastic delivered by a nozzle of fresh mastic production unit on previously prepared surfaces. In this implementation, the nozzle delivering the fresh mastic is not necessarily mobile and the form of the bead deposited on a part is obtained by the displacement of the part while the nozzle delivers the fresh mastic. The part which is in this case held by the preparation robot can then be positioned on the other part as soon as the bead of mastic has been deposited.

In one implementation, the method comprises a preliminary step of loading, in a monitoring and control system of at least one robot, of data characterizing the surfaces of the parts having to be prepared and surfaces on which mastic has to be deposited and characterizing a trajectory position-wise and orientation-wise of the cold plasma torch or torches and of the nozzle or nozzles relative to the parts.

It is thus possible, according to the method, to perform an automatic displacement of the means positioning the cold plasma jet and the bead of mastic relative to the parts having to be prepared.

In order to be tolerant to errors of position of parts to be treated and improve the accuracy of the surface preparation and mastic deposition operations, the theoretical data previously loaded are readjusted as and when necessary by a conventional method implementing the detection of characteristic portions of the parts, for example the edges of the parts or targets placed on the part, that can be recognized by optical means or by other types of sensors.

According to one implementation of the method, a plurality of second parts are assembled with the first part and:
the surface preparation step is performed for the plurality of second parts and for the part with which said plurality of parts has to be assembled, then;
for each of the second parts, the steps a) of deposition of a bead of fresh mastic, b) of positioning, by the preparation robot, of the second part considered having to be assembled on the first part and c) of fitting of temporary fastening devices and of clamping of the second part considered with said first part by a pinning robot are performed in succession, the steps a), b) and c) being performed on a second part considered before being performed on another part of the plurality of second parts.

By thus sequencing the deposition of the bead of fresh mastic and the pre-assembly for each of the second parts, exposure of the fresh mastic to any pollutant is avoided, and the reduction of the time between the deposition of the fresh mastic and the pre-assembly makes it possible to implement mastics that have a faster polymerization than for the conventional methods, hence a reduction of the assembly cycles.

The disclosed embodiment relates also to a device for the pre-assembly of structural parts to be assembled with the interposition of mastic.

The device of the disclosed embodiment comprises:
at least one preparation robot of which an effector comprises one or more cold plasma torches and comprises a gripper suitable for grasping parts to be assembled;
control and monitoring means for the preparation robot;
a first frame for keeping a first part fixed in the device;
a second frame for holding a second part or a plurality of second parts having to be displaced in the device by a preparation robot;
at least one unit for producing fresh mastic and dispensing fresh mastic through at least one nozzle of said production unit to deposit a bead of mastic on the first part and/or the second part or parts.

Thus, the device comprises the means necessary to the preparation of a surface by the spraying, onto the surfaces to be prepared, of a cold plasma and to the deposition of mastic with the benefits expected of the method for preparing the parts and the means for manipulating the parts.

Advantageously, the device also comprises at least one pinning robot operating as slave to the preparation robot in the fitting of temporary fastening devices intended to fix the at least one second part to the first part. Such a pinning robot makes it possible, in a way coordinated with the positioning of a second part on the first part, to fit the temporary fastening devices which will keep the second part and the first part fixed together while the preparation robot goes to prepare another second part.

Advantageously, the cold plasma torch or torches are arranged to produce, in operation, a cold plasma jet with an effective width substantially equal to a width of a surface to be prepared.

The desired surface, of a width corresponding to the width of the cold plasma jet, is thus prepared by a displacement along a length of the surface.

Advantageously, the nozzle or nozzles are arranged to deposit a bead of fresh mastic of which the average diameter corresponds to a volume per unit of length substantially equal to a width of the surface having to be covered with mastic in the assembly to be produced and of a substantially constant desired thickness.

A bead of fresh mastic corresponding to the desired characteristics is thus deposited in one pass of the nozzle or nozzles on the surface of the part on which a mastic seal has to be formed, the bead being flattened upon the pre-assembly of the parts by the temporary fastening devices to assume the final form of the seal. The controlled volume of the bead of fresh mastic deposited avoids the creep of an excess of mastic outside of the zone of the surfaces placed in contact in the assembly and thus makes it possible to optimize the quantity of mastic used and avoid or minimize the operations to remove the excess mastic that has crept between the assembled parts.

According to one aspect of the device, a fresh mastic production unit is combined with a preparation robot and at least one nozzle is borne by the effector of said preparation robot.

According to another aspect of the device, the at least one fresh mastic production unit is arranged in the device such that the nozzle or nozzles of said production unit, delivering fresh mastic, are separate from the preparation robot or robots and situated within an action radius of the effector of a preparation robot.

These two aspects being able to coexist on a same device make it possible to dispense the fresh mastic with the implementation of the preparation robot, each of the aspects being able to prove better suited to particular part dimensions and forms.

In one aspect, a cover is secured to the effector and protects a volume affected by the cold plasma jet, a volume contained between an output of the cold plasma torch or torches and the surface of a part currently undergoing preparation.

Such a cover provides a safety feature for the people who may be located in proximity to the effector when the latter is in operation and also protects the zone being prepared by isolating it, at least partially, from the environment before the deposition of the mastic.

In one aspect, the fresh mastic feeding the nozzles is obtained by a continuous mixing of two components of the mastic stored in distinct containers.

Thus, the mixing of the components of the mastic is performed shortly before the deposition of the mastic which makes it possible to begin the polymerization of the mastic at ambient temperature as late as possible and not have to manage strict application times on the robots that may be required to work almost continuously over long periods.

Advantageously, the device comprises frames suitable for holding the parts to be prepared in a determined position relative to the robots.

In one aspect of the device, a given robot is able to prepare several parts that have to be assembled.

Notably, the second frame is configured to hold a plurality of second parts having to be pre-assembled with the first part (90).

In one aspect of the device, that can be combined with the preceding aspect, several robots are arranged in order to be able to prepare different surfaces of a same part.

It is thus possible to arrange devices for which the number and the arrangement of the robots allow productivity gains and possibilities of being adapted to different parts to be prepared and pre-assemblies to be produced.

A device is then obtained which makes it possible to deliver assemblies of pre-assembled parts which will be able to be subjected to a subsequent final assembly step.

### BRIEF DESCRIPTION OF THE DRAWINGS

The description of the disclosed embodiment is made with reference to the Figures which represent schematically and in a nonlimiting manner:

FIG. 1 is a perspective view of a preparation robot of the device for pre-assembling parts during a part preparation operation;

FIG. 2 is an illustration of a first aspect of a device for pre-assembling parts that have to be assembled in which a preparation robot prepares parts having to be pre-assembled with a part of larger dimensions by performing, in addition to the surface preparation, the deposition of a bead of fresh mastic;

FIG. 3 is an illustration of a second aspect of a device for pre-assembling parts that have to be assembled in which a preparation robot prepares, in a first step, surfaces of the parts having to be pre-assembled with a part of larger dimensions;

FIG. 4 is an illustration of the pre-assembling device of FIG. 3 in which a preparation robot displaces, in a second step, a part to perform the deposition of fresh mastic through a nozzle separate from the preparation robot while the pinning robot is awaiting the positioning of the part on which the deposition of fresh mastic is currently being carried out;

FIG. 5 is a schematic representation of an example. of a method for pre-assembling parts having to be assembled with the interposition of mastic.

The Figures illustrate examples of devices 100 for pre-assembling structural parts according to the disclosed embodiment implemented in the context of the assembly of airplane fuselage panels.

### DETAILED DESCRIPTION

The pre-assembly is understood here to be the assembly, by temporary fastening devices, of parts previously prepared and placed in the relative positions that they need to have with a separating mastic. The preparation of a part comprises, in this case, a succession of operations including a surface preparation of certain surfaces of the part and a deposition of mastic on the prepared surfaces.

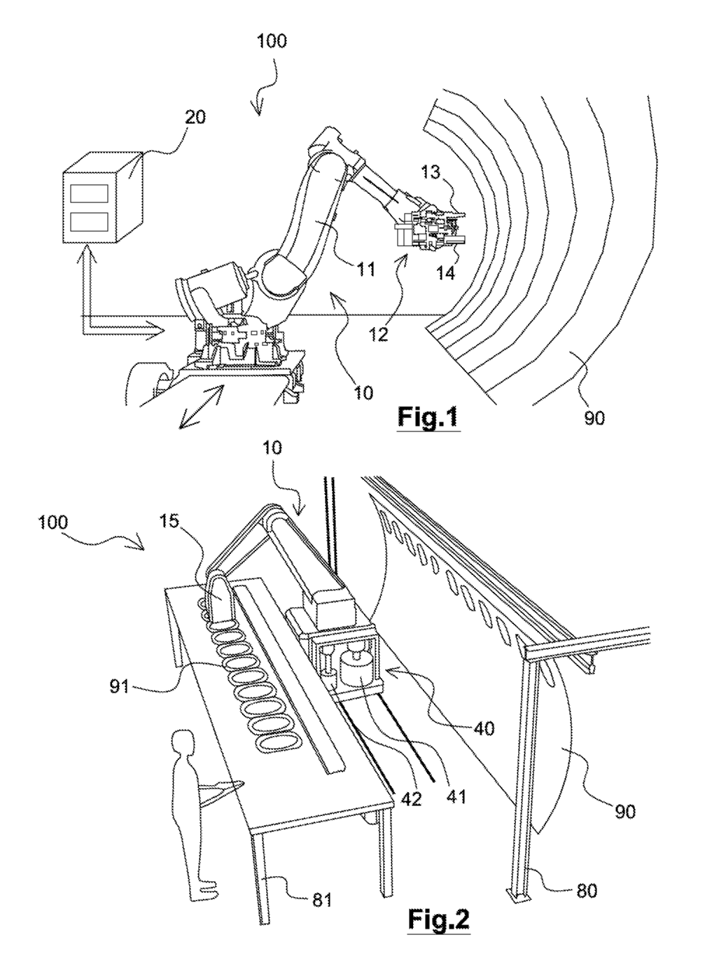

In FIG. 1, a first part 90, in the example illustrated a fuselage panel of an airplane, is represented alone. The first part 90 is held in a desired position for its preparation by a manufacturing tool, for example a frame, not represented in the Figure.

The device 100 comprises a preparation robot 10 and monitoring and control means 20 of said preparation robot.

The preparation robot 10, in the example illustrated a multi-axis robot with articulated arm on a translationally mobile base for the preparation of elongate parts, comprises an arm 11 bearing, at a free end, an effector 12.

The preparation robot 10 is designed with dimensions, in particular lengths of different articulated segments of the arm 11, and a mobility such that the effector 12 can be placed, with a desired orientation, facing all the locations were a surface preparation is desired.

The monitoring means 20 mainly comprise a numerical control center for the preparation robot 10 and utilities of the robot providing the resources necessary for said preparation robot, in particular energy. The numerical control center comprises a program which manages the displacements of said preparation robot and of the arm 11 for the effector 12 to follow a desired trajectory relative to the part and which manages the equipment of the effector 12.

The equipment of the effector 12 primarily includes at least one cold plasma torch 13 and a gripper 14 for a part to be prepared and assembled.

The cold plasma torch 13 is a generator producing a jet of a plasma at atmospheric pressure comprising ionized particles and electrons, the jet being substantially electrically neutral. According to the cold plasma technology, the temperature of the electrons and therefore their energies are very much greater than those of the ions. The electrons have, in a cold plasma, collision reaction capacities that they do not have in ordinary conditions and the ions have chemical reaction capacities with the materials that they encounter that are limited by their relatively low temperatures, in the field considered less than 420 K static temperature.

Another feature of the cold plasma torch 13 is that it produces an unconfined jet which is propagated in free air and which can be produced continuously provided that the cold plasma torch is fed with a current at high voltage and with compressed gas with a desired flow rate for the plasma torch.

When sprayed onto a material, the plasma acts mechanically by virtue of the speed of the plasma jet, chemically by reaction of the ions, and thermally as a function of the temperature of the ions. By an adjustment of the parameters of the cold plasma torch (temperature, flow rate) and its implementation (distance to the surface treated, exposure time), parameters that are functions of the constituent materials of the part to be cleaned, a degreasing and a cleaning of the surfaces subjected to the jet from the cold plasma torch is obtained.

The gripper 14 is a terminal element of the arm 11 borne by the effector 12 which allows the preparation robot 10 to grasp a part to position it on a pre-assembly station.

As will be specified later, the gripper 14 allows the robot to displace parts having to be handled for the purposes of their preparations before being positioned.

In FIG. 2 representing the device 100, a frame 81 holds a plurality of second parts 91, in the example illustrated frames of windows, having to be assembled with the first part 90, currently being prepared by the preparation robot 10.

The absence of direct mechanical action on the second parts 91, as would be the case for a cleaning by means of an abrasive disk, avoids having to clamp said second parts during their preparations, the weight of each of the second parts being sufficient to stabilize them on the frame 81.

In the aspect illustrated in FIG. 2, the effector of the preparation robot 10 also comprises a fresh mastic dispensing nozzle.

The fresh mastic dispensing nozzle is for example an extrusion device terminated by a die of gauged section adapted to the quantity of fresh mastic having to be deposited and to the desired form for a bead of mastic deposited on the part, most often a bead of substantially circular section.

The nozzle is fed with fresh mastic by a mastic production unit 40 with a flow rate taking into account the rate of displacement of the nozzle borne by the effector 12 of the preparation robot 10 relative to the part on which the fresh mastic is deposited, when the preparation robot performs the deposition of a bead of mastic on a surface previously cleaned by means of the cold plasma torch.

In one aspect, the mastic is pushed to the nozzle by a device such as a piston or a worm screw from a tank of fresh mastic, that is to say in which the components are freshly mixed, containing a quantity suitable for the preparation of a part or of a set of parts in a time compatible with the implementation of the mastic, generally several hours.

In another aspect, the different components of the mastic are kept in separate tanks and mixed before being introduced into the nozzle 14 such that only the quantity of fresh mastic necessary is produced during the preparation of the parts.

In the exemplary aspect of FIG. 2, the cold plasma torch 13 and the nozzle are arranged on the effector 12 such that the preparation robot 10 is able to perform a surface preparation with said cold plasma torch in a first step then deposit a bead of mastic with said nozzle in a second step by displacements of the effector 12 relative to the parts in preparation.

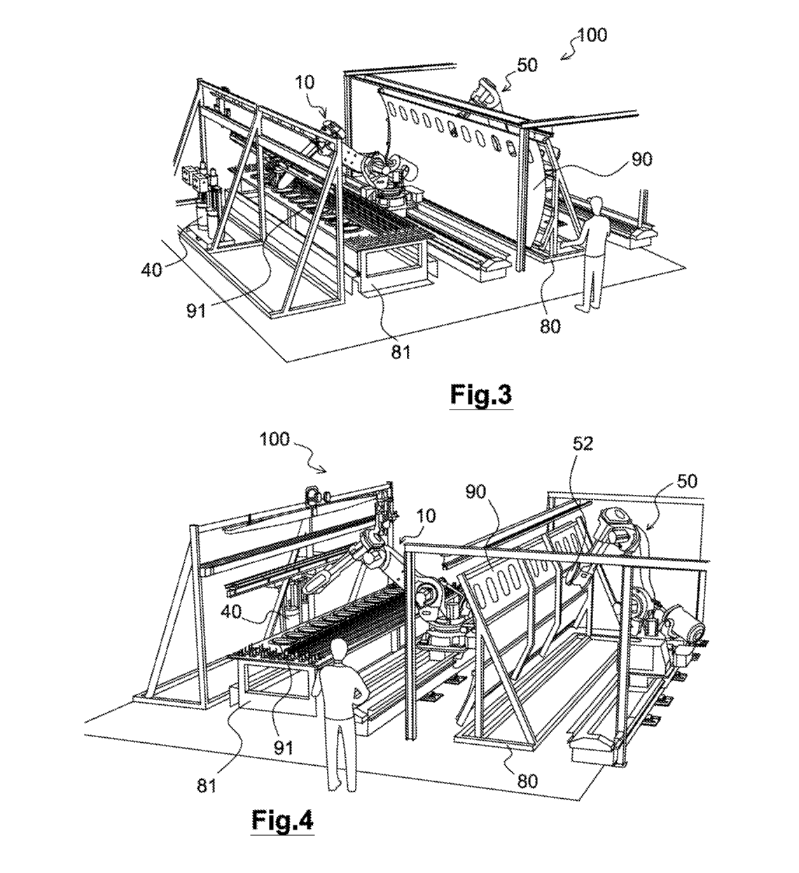

FIG. 3 presents an exemplary aspect of the device 100, similar to the device illustrated in FIG. 2, but in which the effector 12 of the preparation robot 10 does not comprise a nozzle and does not deliver mastic.

In this exemplary aspect of the device 100, one or more mastic dispensing units 40 are configured to deliver a bead of mastic of suitable geometry, as in the preceding exemplary aspect, but said mastic dispensing units are arranged on separate stations within an action perimeter of the effector 12 of the preparation robot 10.

Thus, when a bead of mastic has to be deposited, the preparation robot 10 grasps the part with the gripper 14 of the effector 12 and, as represented in FIG. 4, displaces the latter in an axis of the die of the nozzle delivering the fresh mastic.

By a suitable displacement of the grasped part, of bead of fresh mastic is deposited at the desired location without displacement of the nozzle, at the most with simplified displacements of the nozzle for example along an axis.

The mastic dispensing units 40 are for example arranged stationary as in the example illustrated.

In another aspect, not illustrated, one or more mastic dispensing units are arranged mobile, for example on rails, so as to follow at least partly displacements of the preparation robot 10 such that the movements of the preparation robot to perform the deposition of the bead of fresh mastic on a part are limited, in particular when a series of parts arranged on a support frame is prepared.

In the exemplary device 100 of FIGS. 2, 3, and 4, the following points should be noted.

The first part 90 and second parts 91 currently being prepared do not need to be clamped, or need only weak clamping for light parts, the jet from the plasma torch producing a surface preparation without generating significant forces, and the deposition or fresh mastic by the nozzle, although performed with contact, generates only a minimal force on the parts.

The effector 12 of each preparation robot 10 is protected by a cover 15, necessarily open on the side of the surface of the part in preparation, which ensures the safety of people who may be located in proximity to the effector. Advantageously, the cold plasma torch is activated only when the cover 15 is close enough to the part for an operator not to be able to introduce his or her hand into the plasma jet. Advantageously, suction means suck, into the cavity of the covey 15, vapors given off during the surface preparation by cold plasma and, if necessary, by the fresh mastic upon its deposition.

In one aspect, each fresh mastic dispensing unit 40 comprises a reserve of each of the components of the mastic in separate containers 41, 42, in the example illustrated in FIG. 2 cylindrical tanks, the components being mixed by means that are not visible in the Figure in desired proportions to form fresh mastic pushed to the nozzle.

It should be noted that, if permitted by dimensions of the parts to be prepared, the device 100 can comprise several preparation robots, preparation robots which can be with fixed or mobile bases and distributed to work in parallel without interference.

Furthermore, the preparation robot or robots can have different forms from those illustrated, provided that the means bearing the effector are shaped to displace and orient the effector as is desired relative to the parts to be prepared and to be pre-assembled.

The effector, depending on the dimensions of the surfaces to be prepared and to be covered with mastic, can comprise one or more cold plasma torches and, if necessary, one or more nozzles for depositing mastic. When the effector comprises several cold plasma torches or several nozzles, the monitoring and control means 20 manages the activation of all or some of the torches and of the nozzles according to the width of the surfaces to be treated which is not necessarily constant over a part or between different parts that may be prepared on the same device 100.

Considering once again the device 100 as a whole, said device also comprises at least one pinning robot 50.

A pinning robot 50 is represented in FIGS. 3 and 4.

The pinning robot is not used for the preparation of the parts having to be pre-assembled and is implemented for the pre-assembly needs when a second part 91 is positioned on the first part 90.

The displacements and operations performed by the pinning robot 50 are controlled, as for the preparation robot 10, by monitoring and control means which are coupled to the monitoring and control means 20 of the preparation robot. In the device 100, a pinning robot 50 is slaved to a preparation robot 10.

The pinning robot 50 comprises an effector 52 suitable for fitting temporary fastening devices.

In the device 100, the pinning robot 50 is situated on a rear face of the first part 90, held by the frame 80, opposite a front face subjected to a surface preparation by means of the preparation robot 10 and on which front face the second parts 91 have to be fixed for the pre-assembly to be performed.

The pinning robot 50 is, for example but not necessarily, a robot similar to the preparation robot 10 comprising an articulated arm 51 with the desired degrees of freedom for the fitting of the temporary fastening devices and, if necessary mobile for example on rails.

In the context of a pre-assembly workshop having to pre-assemble sets of parts to form different assembled structures, the preparation and pinning robots advantageously have the capacity to change effectors according to the parts to be prepared and to be pre-assembled.

For example, different effectors are arranged in an effector store in which a robot, controlled by the control and monitoring center, will select and mount on the arm of said robot an effector suited to an operation that has to be carried out.

The arrangement of the device, and of its possible variants, will be better understood from the description of the implementation of the pre-assembly method and of the step of preparation of the parts for their assembly with the interposition of mastic.

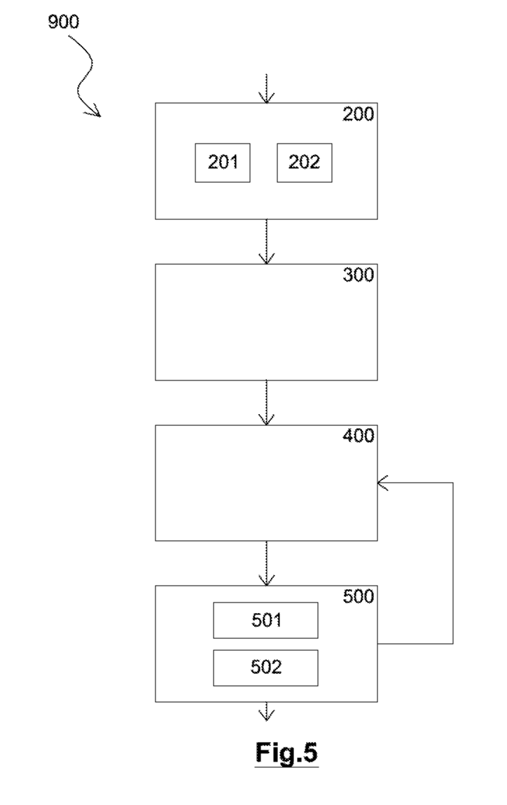

To perform the pre-assembly of a first part 90 with at least one second part 91, with the interposition of a mastic on the parts in contact of said first and second parts, a method 900 according to FIG. 5 is implemented comprising the following steps.

In a first step 200 of the method, the first 90 and second 51 parts are placed 201 held by frames 80, 81 in order to prepare surfaces of said first and second parts that have to be located in contact with one another with the interposition of the mastic and data are entered 202, for example by means of a numerical driver file for the preparation robot 10, into the monitoring and control means 20 to define the position of the surfaces having to be prepared and covered with mastic.

In a second step 300, the surfaces of the first part 90 and of the second part or parts 91 having to be located in contact being identified, said surfaces are subjected to at least one jet of a cold plasma produced by a cold plasma torch 13 displaced by the preparation robot 10.

Parameters of the cold plasma jet, such as flow rate, speed of the jet, temperature and exposure time of the surfaces to be cleaned by the jet, determined in particular as a function of the material of the part and desired surface preparation results, for example verified by tests, are also entered in the step 202 into the monitoring and control means 20 to be applied by the preparation robot according to the prepared location.

The cold plasma makes it possible, without degrading the material of the part, to clean the treated surface by destroying dust, grease and organic compounds polluting the surface of the part.

Furthermore, the electrical neutrality of the cold plasma does not electrically charge the treated surface which, because of this, does not have a tendency to electrostatically attract new dust before the deposition of the mastic.

The cold plasma also modifies the physical structure of the surface, in particular by creating a surface condition with a roughness that promotes the attachment of the mastics.

During this second step 300, the cold plasma jet is displaced along a programmed trajectory to clean the surfaces that have to be covered with mastic.

It should be noted here that, in many structural part assembly fields, the surfaces placed in contact are, most often, of small width relative to their length.

In these cases, advantageously, the plasma jet will be arranged to correspond dimension-wise to the width of the surfaces to be cleaned, if necessary by combining several cold plasma torches, and the jet will be displaced along the length of said surfaces to be cleaned.

In a third step 400, a bead of fresh mastic is deposited on surfaces cleaned by the plasma jet.

The deposition 400 of fresh mastic is however performed only when the temperature of the surface on which the mastic is deposited, a temperature which is high in the step 300 of surface preparation by the cold plasma, is lowered below a value allowed to avoid a premature polymerization of the mastic, for example below a temperature of 30° C.

This temperature condition can be verified by a measurement by means of a temperature sensor with or without contact.

It can also be established, after calibration, by a relaxation time after the pass of the cold plasma torch, a relaxation time which can be a function of the ambient temperature in the workshop where the pre-assembly is performed.

If necessary, the cooling is accelerated after the pass of the plasma torch by blowing a cold gas, for example air or nitrogen.

“Bead of fresh mastic” should be understood to convey the fact that a fresh mastic, that is to say mastic whose polymerization has not yet substantially affected the desired viscosity for the implementation thereof, is deposited substantially continuo with a desired volume per length on the cleaned surfaces.

The characteristics of the bead of fresh mastic result from the form of a die of the nozzle used to deposit the fresh mastic, the flow rate of the mastic delivered said nozzle and a rate of displacement of the nozzle.

It should be noted that the fresh mastic is not necessarily deposited on the surfaces of both parts having to be assembled but, preferably, is deposited only on one of the two parts, the quantity of fresh mastic being adjusted according to the case.

In a fourth step 500, when all the surfaces in contact of the first part 90 and of at least one second part 91 have been prepared, and a bead of fresh mastic has been deposited on at least one of the parts, the two parts 90, 91 are pre-assembled, within a time period during which the mastic can still be worked, in the relative position that they need to have in the assembly to be produced.

For this pre-assembly step, the preparation robot 10 grasps a second part 91, in the example illustrated a window frame, and positions 501 the grasped part on the first part 90, in the example illustrated the fuselage panel, held fixed.

Then, the pinning robot 50, working from an opposite side of the first part 90, held stationary, and acting in a coordinated manner with the preparation robot 10 bearing the grasped second part 91, places 502 temporary fastening devices which keep the surfaces contact clamped.

In this configuration, assembly robot 10 master and the pinning robot 50 is slave.

During this positioning of the grasped part and the clamping produced by the temporary fastening devices, the bead of mastic is flattened to form a film of mastic, relatively thin, on the surfaces placed in contact in the assembly.

In a subsequent step, if necessary, when the mastic has reached a desired polymerization, as is known, the temporary fastening devices will be removed and final fastening devices will be put in place to produce the assembly.

In a preferred procedure the step 300 comprises the surface preparation by the preparation robot 10 of all the surfaces having to be prepared for the first part 90 and for a plurality of second parts 91 awaiting pre-assembly on the device 100.

Then, for each second part of said plurality, the mastic is deposited according to the procedure of the step 400 and the second part considered is positioned, step 501, on the first part held fixed for the fitting of the temporary fastening devices, step 502.

The steps 400 and 500 are then repeated as many times as necessary for each of the second parts prepared in the surface preparation step 300.

Thus, the mastic, once deposited, is not exposed to any pollution and polymerizes only a minimum time before the positioning and the fitting of the temporary fastening devices.

The speed of execution of the pre-assembly also makes it possible to implement mastics with a faster polymerization and makes it possible to reduce the assembly cycles incorporating a fitting of the final fastening devices.

The method according to the disclosed embodiment, and the device particularly suited to the method, make it possible to perform the pre-assembly of structural elements with many advantages. Notably, the method:
makes it possible to control the quantity of mastic deposited with perfect reproducibility of the results, hence reduced mastic consumption, the frequent excesses of material in the manual methods being avoided;
avoids the production of dust of the mechanical cleaning methods of the prior solutions and therefore the pollution of the workshop and of the surfaces to which the mastic must adhere;
avoids the use of solvents and of consumables such as the towelettes and gloves;
by performing the tasks that can lead to uncomfortable positions and attitudes, limits the risks of musculoskeletal disorders among operators working on the assembly of the parts.

Finally, in particular by performing the surface preparation quickly followed by the deposition of the mastic, the method makes it possible to perform the pre-assembly operations with a reduced time compared to the known solutions.

What is claimed is:

1. A method for pre-assembling a first part with at least one second part and with the interposition of a mastic in which surfaces of first and second parts having to be placed in contact are subjected to a surface preparation operation followed by a deposition of a fresh polymerizable mastic on the prepared surface of at least one of the first or second parts and in which said first part and at least one second part are pre-assembled by temporary fastening devices, the method comprising the steps of:
preparation of the surfaces, having to be placed in contact, of the first part and of the at least one second part by the spraying, onto the surfaces to be prepared, of a cold plasma jet generated by at least one cold plasma torch borne by an effector of at least one preparation robot, then;
cooling of said surfaces haying to be placed in contact to a temperature below a temperature allowed for the deposition of fresh mastic, then;
deposition a bead of fresh mastic, by means of the preparation robot, on the surfaces haying to be placed in contact of the first part and/or of the at least one second part, then;
positioning, by the preparation robot, of said at least one second part on the first part, then;
fitting of temporary fastening devices and clamping of said at least one second part with the first part by a pinning robot, when the mastic is still fresh.

2. The method as claimed in claim 1, wherein the bead of fresh mastic is deposited by means of a nozzle of a mastic production unit, by displacement of said nozzle borne by the effector of the preparation robot over previously prepared surfaces of the first part and at least one second part, said first and second parts being kept individually fixed on frames.

3. The method as claimed in claim 1, wherein the preparation robot displaces a part, held by gripping means of the effector of said preparation robot, to deposit a bead of fresh mastic delivered by a nozzle of a fresh mastic production unit on previously prepared surfaces.

4. The method as claimed in claim 2, comprising a preliminary step of loading, in a monitoring and control system at least one preparation robot, of data wherein the surfaces of the parts having to be prepared and surfaces on which mastic has to be deposited and wherein a trajectory position-wise and orientation-wise of the cold plasma torch or torches and of the nozzle or nozzles relative to the parts.

5. The method as claimed in claim 1, wherein a plurality of second parts are assembled with the first part and wherein:
the surface preparation step is performed for the plurality of second parts and for the part with which said plurality of parts has to be assembled then;
for each of the second parts of the plurality of second parts the steps a) of deposition of a bead of fresh mastic, b) of positioning, by the preparation robot, of the second part considered having to be assembled on the first part and c) of fitting of temporary fastening devices and of clamping of the second part considered with said first part by a pinning robot are performed in succession, the steps a), b) and c) being performed on a second part considered before being performed on another part of the plurality of second parts.

6. A device for pre-assembling structural parts to be assembled with the interposition of mastic comprising:
at least one preparation robot of which an effector comprises at least one cold plasma torch and a gripper suitable for grasping parts to be assembled;
control and monitoring means for the preparation robot;
a first frame arranged to keep a first part fixed in the device;
a second frame arranged to hold at least one second part having to be displaced in the device by a preparation robot;
at least one unit for producing fresh mastic and dispensing fresh mastic through at least one nozzle of said production unit to deposit a bead of mastic on the first part and/or the second part or parts.

7. The device as claimed in claim 6, further comprising at least one pinning robot operating as slave to the preparation robot in the fitting of temporary fastening devices intended to fix the at least one second part to the first part.

8. The device as claimed in claim 6, wherein the cold plasma torch or torches are arranged to produce, in operation, a cold plasma jet with an effective width substantially equal to a width of a surface to be prepared.

9. The device as claimed in claim 6, wherein the nozzle or nozzles are arranged to deposit a bead of fresh mastic of an average diameter corresponding to a volume per unit of length substantially equal to a width of a surface having to be covered with mastic in the assembly to be produced and of a substantially constant desired thickness.

10. The device as claimed in claim 6, wherein a fresh mastic production unit is combined with a preparation robot and the at least one nozzle is borne by the effector of said preparation robot.

11. The device as claimed in claim 6, wherein the at least one fresh mastic production unit is arranged in the device such that the nozzle or nozzles of said production unit, delivering fresh mastic, are separate from the preparation robot or robots and situated within an action radius of the effector of a preparation robot.

12. The device as claimed in claim 6, wherein a cover secured to the effector protects a volume affected by the cold plasma jet, contained between an output of the cold plasma torch or torches and a surface of a part currently undergoing surface preparation.

13. The device as claimed in claim 6, wherein the fresh mastic feeding one or more nozzles is obtained by a continuous mixing of two components of the mastic stored in distinct containers.

14. The device as claimed in claim 6, wherein the second frame is configured to hold a plurality of second parts having to be pre-assembled with the first part.
